(19) United States
(12) Patent Application Publication
(10) Pub. No.: US 2025/0249291 A1
(43) Pub. Date: Aug. 7, 2025

(54) Inflatable Fire Escape Slide Device

(71) Applicant: Mildrenia Bates, Cincinnati, OH (US)

(72) Inventor: Mildrenia Bates, Cincinnati, OH (US)

(21) Appl. No.: 18/652,843

(22) Filed: May 2, 2024

Related U.S. Application Data
(60) Provisional application No. 63/548,936, filed on Feb. 2, 2024.

(51) Int. Cl. A62B 1/20

(52) U.S. Cl. CPC A62B 1/20

(57) ABSTRACT

An inflatable fire escape slide device is provided. The device is comprised of an inflatable slide system designed for emergency evacuations from buildings. The device comprises a body made of two halves connected by at least one hinge or similar fastener. One of the halves can be attached to a windowsill using a spring-loaded slam latch to secure the device to a windowsill during use. An inflatable slide housed within the body can be deployed and inflated by a spring-loaded release mechanism activated by pulling a string, which allows compressed air to exit a compression chamber, thus inflating the slide rapidly. The slide includes a protective tarp at its base to prevent damage and absorb the impact of users after sliding down the slide from a building window to a ground surface.

### CROSS-REFERENCE TO RELATED APPLICATION

The present application claims priority to, and the benefit of, U.S. Provisional Application No. 63/548,936, which was filed on Feb. 2, 2024, and is incorporated herein by reference in its entirety.

### FIELD OF THE INVENTION

The present invention relates generally to the field of emergency building evacuation devices. More specifically, the present invention relates to a window-attachable inflatable slide that can be used to exit a multi-story building in the event of a fire or other emergency. Accordingly, the present disclosure makes specific reference thereto. Nonetheless, it is to be appreciated that aspects of the present invention are also equally applicable to other like applications, devices, and methods of manufacture.

### BACKGROUND

Emergency situations occurring in residential homes, office buildings, and other structures, such as fires, present exceptionally hazardous conditions that necessitate an immediate evacuation. However, individuals residing or working on the upper floors of multi-story buildings often face significant challenges in escaping safely due to their elevated location. The option of jumping from such heights is fraught with risks, including the potential for severe injuries or even death. Moreover, emergency response teams may encounter delays in reaching the affected site promptly due to various factors such as traffic, location, or the scale of the emergency. This can critically hinder their ability to intervene effectively and save lives in a timely manner.

Therefore, there exists a long-felt need in the art for an improved evacuation device for buildings and other structures. There also exists a long-felt need in the art for an inflatable fire escape slide device. Further, there exists a long-felt need in the art for an inflatable fire escape slide device that allows a user to escape a multi-story building. More specifically, there exists a long-felt need in the art for an inflatable fire escape slide device that allows a user to escape a multi-story building via an inflatable slide.

The subject matter disclosed and claimed herein, in one embodiment thereof, comprises an inflatable fire escape slide device. The device is comprised of an inflatable slide system designed for emergency evacuations from buildings. The device comprises a body made of two halves connected by at least one hinge or similar fastener. One of the halves can be attached to a windowsill using a spring-loaded slam latch to secure the device to a windowsill during use. An inflatable slide housed within the body can be deployed and inflated by a spring-loaded release mechanism activated by pulling a string, which allows compressed air to exit a compression chamber, thus inflating the slide rapidly. The slide includes a protective tarp at its base to prevent damage and absorb the impact of users after sliding down the slide from a building window to a ground surface.

In this manner, the inflatable fire escape slide device of the present invention accomplishes all the forgoing objectives and provides an improved evacuation device for buildings and other structures. More specifically, the device allows a user to escape a multi-story building. More specifically, the device does so via an inflatable slide.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an inflatable fire escape slide device comprised of a body comprised of a first half and a second half. The first half may be partially attached to the second half via at least one hinge or other similar fastener type of the like. The exterior surface of the first half (or the second half in another embodiment), is comprised of at least one fastener that allows the half to attach to/around a windowsill during use of the device.

After attaching the device to/around a windowsill via the fastener, at least one fastener can be undone/released to allow the first half to separate from the second half. After the halves have been separated, at least one inflatable slide extends out from inside the body. More specifically, the slide can be rapidly inflated by pulling at least one pull string or other similar mechanism that activates a spring-loaded release mechanism, such as but not limited to a valve) that allows compressed air to exit a compression chamber, which inflates the slide.

The slide is also comprised of at least one tarp positioned at the bottom of the slide. The tarp protects the slide and users from damage while using the device. The tarp may also absorb the impact of landing and prevent abrasions when exiting the slide. When fully inflated, a user can slide down the slide to escape a fire within a building.

The device is also comprised of a method of using the device. First, a device is provided comprised of a body comprised of at least one fastener and an internal slide that can be inflated via a compression chamber. Next, the body can be attached to and/or around a window and/or windowsill via the fastener. Next, the body can be opened by releasing at least one fastener. Then, a pull string can be pulled to inflate the slide such that the slide touches a ground surface near the building or structure where the device was deployed. Finally, a user can slide down the slide to safely exit the building or structure.

Accordingly, the inflatable fire escape slide device of the present invention is particularly advantageous as it provides an improved evacuation device for buildings and other structures. More specifically, the device allows a user to escape a multi-story building. More specifically, the device does so via an inflatable slide. In this manner, the inflatable fire escape slide device overcomes the limitations of existing multi-story building evacuation methods and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an inflatable fire escape slide device of the present invention while closed in accordance with the disclosed architecture;

FIG. 2 illustrates a perspective view of one potential embodiment of an inflatable fire escape slide device of the present invention while open with an inflated slide in accordance with the disclosed architecture; and

FIG. 3 illustrates a flowchart of a method of using one potential embodiment of an inflatable fire escape slide device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved evacuation device for buildings and other structures. There also exists a long-felt need in the art for an inflatable fire escape slide device. Further, there exists a long-felt need in the art for an inflatable fire escape slide device that allows a user to escape a multi-story building. More specifically, there exists a long-felt need in the art for an inflatable fire escape slide device that allows a user to escape a multi-story building via an inflatable slide.

The present invention, in one exemplary embodiment, is comprised of an inflatable fire escape slide device. The device is comprised of a body comprised of a first half and a second half, wherein the first half may be partially attached to the second half via at least one hinge or other similar fastener type of the like. The exterior surface of the first half (or the second half in another embodiment), is comprised of at least one fastener. The fastener allows the half to attach to/around a windowsill during the use of the device.

After attaching the device to/around a windowsill via the fastener, at least one fastener can be undone/released to allow the first half to separate from the second half. After the halves have been separated, at least one inflatable slide extends out from inside the body. More specifically, the slide can be rapidly inflated by pulling at least one pull string or other similar mechanism that activates a spring-loaded release mechanism, such as but not limited to a valve) that allows compressed air to exit a compression chamber, which inflates the slide.

The slide is also comprised of at least one tarp positioned at the bottom of the slide. The tarp protects the slide and users from damage while using the device. The tarp may also absorb the impact of landing and prevent abrasions when exiting the slide. When fully inflated, a user can slide down the slide to escape a fire within a building.

The device is also comprised of a method of using the device. First, a device is provided comprised of a body comprised of at least one fastener and an internal slide that can be inflated via a compression chamber. Next, the body can be attached to and/or around a window and/or windowsill via the fastener. Next, the body can be opened by releasing at least one fastener. Then, a pull string can be pulled to inflate the slide such that the slide touches a ground surface near the building or structure where the device was deployed. Finally, a user can slide down the slide to safely exit the building or structure.

Accordingly, the inflatable fire escape slide device of the present invention is particularly advantageous as it provides an improved evacuation device for buildings and other structures. More specifically, the device allows a user to escape a multi-story building. More specifically, the device does so via an inflatable slide. In this manner, the inflatable fire escape slide device overcomes the limitations of existing multi-story building evacuation methods and devices known in the art.

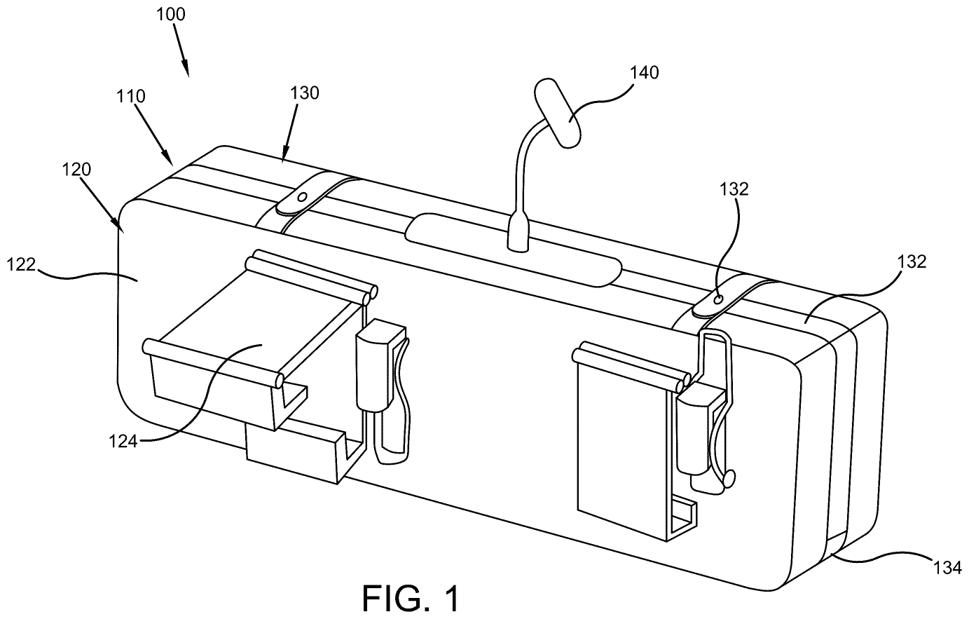

Referring initially to the drawings, FIG. 1 illustrates a perspective view of one potential embodiment of an inflatable fire escape slide device of the present invention while closed in accordance with the disclosed architecture. The device 100 is comprised of a body 110 that may be made from any material. The body 110 is comprised of a first half 120 and a second half 130. The first half 120 may be partially attached to the second half 130 via at least one hinge 134 or other similar fastener type of the like. The exterior surface 122 of the first half 120 (or the second half 130 in another embodiment), is comprised of at least one fastener 124. The fastener 124 is preferably comprised of a spring-loaded slam latch. The fastener 124 allows the half 120 to attach to/around a windowsill during use of the device 100. The fastener 124 may be positioned on any surface of either half 120,130.

After attaching the device 100 to/around a windowsill via the fastener 124, at least one fastener 132 can be undone/released to allow the first half 120 to separate from the second half 130. The fastener 132 may include but is not limited to a zipper, a draw latch, a clip, etc.

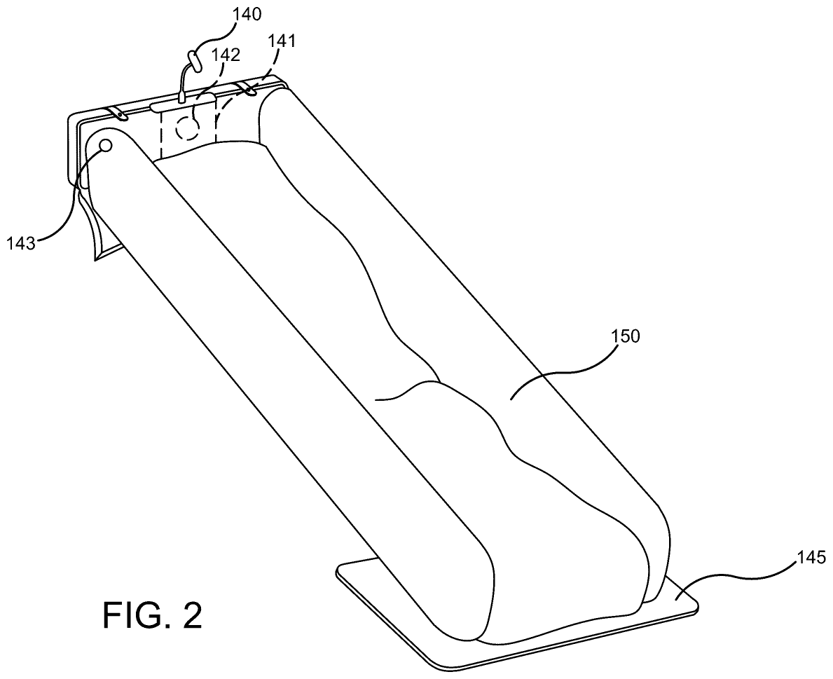

After the halves 120,130 have been separated, at least one inflatable slide 150 extends out from inside the body 110, as seen in FIG. 2. More specifically, the slide 150 can be rapidly inflated by pulling at least one pull string 140 or other similar mechanism that activates a spring-loaded release mechanism 142, such as but not limited to a valve) that allows compressed air to exit a compression chamber 141, which inflates the slide 150. Full inflation of the slide 150 may be indicated via at least one indicator 143 such as but not limited to a pressure gauge. The slide 150 is preferably made from but not limited to a puncture-resistant inflatable material.

The slide 150 is also comprised of at least one tarp 145 positioned at the bottom of the slide. The tarp 145 protects the slide 150 and users from damage while using the device 100. The tarp 145 may also absorb the impact of landing and prevent abrasions when exiting the slide.

When fully inflated, a user can slide down the slide 150 to escape a fire within a building. The slide 150 may differ in size in various embodiments to allow for accommodation of any height of building. It is also contemplated that device 100 can be of unitary construction, such ss a backpack with all the same elements functioning the same way, but with a zippered enclosure instead of latch openings.

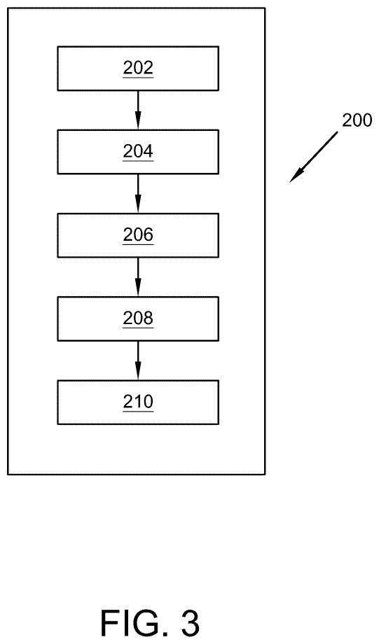

The present invention is also comprised of a method 200 of using the device 100, as seen in FIG. 3. First, a device 100 is provided comprised of a body 110 comprised of at least one fastener 124 and an internal slide 150 that can be inflated via a compression chamber 141 [Step 202]. Next, the body 110 can be attached to and/or around a window and/or windowsill via the fastener 124 [Step 204]. Next, the body 110 can be opened by releasing at least one fastener 132 [Step 206]. Then, a pull string 140 can be pulled to inflate the slide 150 such that the slide 150 touches a ground surface near the building or structure where the device 100 was deployed [Step 208]. Finally, a user can slide down the slide 150 to safely exit the building or structure [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “inflatable fire escape slide device” and “device” are interchangeable and refer to the inflatable fire escape slide device 100 of the present invention.

Notwithstanding the forgoing, the inflatable fire escape slide device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the inflatable fire escape slide device 100 as shown in the FIGS. are for illustrative purposes only, and that many other sizes and shapes of the inflatable fire escape slide device 100 are well within the scope of the present disclosure. Although the dimensions of the inflatable fire escape slide device 100 are important design parameters for user convenience, the inflatable fire escape slide device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An inflatable fire escape slide device comprising:
a body comprised of a first half and a second half;
a fastener attached to the first half or the second half;
a pull string;
a compression chamber; and
an inflatable slide.

2. The inflatable fire escape slide device of claim 1, wherein the fastener is comprised of a spring-loaded slam latch.

3. The inflatable fire escape slide device of claim 1, wherein the compression chamber is comprised of a spring-loaded release mechanism.

4. The inflatable fire escape slide device of claim 3, wherein the spring-loaded release mechanism can be activated by the pull string.

5. The inflatable fire escape slide device of claim 1, wherein the inflatable slide is comprised of a puncture-resistant material.

6. The inflatable fire escape slide device of claim 1, wherein the inflatable slide is comprised of a tarp.

7. The inflatable fire escape slide device of claim 1, wherein the inflatable slide is comprised of a pressure gauge.

8. An inflatable fire escape slide device comprising:
a body comprised of a first half attached second half;
a first fastener attached to the first half or the second half;
a second fastener;
a pull string;
a compression chamber; and
an inflatable slide.

9. The inflatable fire escape slide device of claim 8, wherein the first half attaches to the second half via a hinge.

10. The inflatable fire escape slide device of claim 8, wherein the first fastener is comprised of a spring-loaded slam latch.

11. The inflatable fire escape slide device of claim 8, wherein the second fastener secures the first half to the second half.

12. The inflatable fire escape slide device of claim 11, wherein the second fastener is comprised of a zipper, a draw latch, or a clip.

13. The inflatable fire escape slide device of claim 8, wherein the compression chamber is comprised of a spring-loaded release mechanism.

14. The inflatable fire escape slide device of claim 13, wherein the spring-loaded release mechanism can be activated by the pull string.

15. The inflatable fire escape slide device of claim 8, wherein the inflatable slide is comprised of a puncture-resistant material.

16. The inflatable fire escape slide device of claim 8, wherein the inflatable slide is comprised of a tarp.

17. The inflatable fire escape slide device of claim 8, wherein the inflatable slide is comprised of a pressure gauge.

18. A method of using an inflatable fire escape slide device, the method comprising the following steps:
providing an inflatable fire escape slide device comprised of a body comprised of a fastener and an internal slide that can be inflated by a compression chamber;
attaching the body to a window or a windowsill via the fastener;
opening the body;
inflating the internal slide; and
sliding down the internal slide.

19. The method of using an inflatable fire escape slide device of claim 18, wherein the internal slide is inflated by a compression chamber.

20. The method of using an inflatable fire escape slide device of claim 18, wherein the fastener is comprised of a spring-loaded slam latch.
